(19) United States
(12) Patent Application Publication
(10) Pub. No.: US 2019/0254239 A1
(43) Pub. Date: Aug. 22, 2019

(54) PLANTER BOX

(71) Applicant: Dwayne Williams, Columbus, OH (US)

(72) Inventor: Dwayne Williams, Columbus, OH (US)

(21) Appl. No.: 16/281,296

(22) Filed: Feb. 21, 2019

Related U.S. Application Data
(60) Provisional application No. 62/633,328, filed on Feb. 21, 2018.

(51) Int. Cl. A01G 9/02

(52) U.S. Cl. CPC A01G 9/02

(57) ABSTRACT

According to this invention, there is provided a planter box having four generally rectangular side walls having opposite longitudinal ends of like vertical height and an upper end forming a top edge, a joint structure for joining the opposite ends of respective pairs of sidewalls together into a right angled wall structure and the wall structures into an upwardly open frame. The joint structure has a plurality of L-shaped corner flange plates at right angles to one another. When abutted against and releasably connected to the outwardly facing end portions of a pair of side walls the plates form one right angled wall structure. The plate includes fastening members for joining the structure together.

### CROSS-REFERENCE TO RELATED APPLICATION

This application is a completion application of co-pending U.S. provisional application, Ser. No. 62/633,328, filed Feb. 21, 2018 for “Planter Box” the disclosure of which is hereby incorporated by reference in its entirety, including the drawings.

### BACKGROUND OF THE INVENTION

### 1. Field of the Invention

The present invention generally relates to planter boxes and more particularly relates to a planter box that includes four wall members that are assembled, and disassembled, by corner connectors and gussets with readily available tools to form a rectangular shaped frame for supporting a soil pouch in the frame.

### 2. Description of the Prior Art

Planter boxes hold soil, plants, and other heavy and often damp items. Typically, planter boxes are fabricated from wood, ceramic, or plastic. Planter boxes, when assembled, take up space and are difficult to assemble or disassemble without tools to transport or ship.

Fasteners, panels, structural supports and other components used in the assembly of planter boxes often require the assembly of panels using tools and fasteners. This can be difficult and time consuming.

The fasteners are often in contact with the soil and moisture required for the plants. Fasteners and other components often corrode over time, which may lead to collapse of the planter box, release of dirt, damage to plants, and hazardous situations.

Additionally, ceramic planter boxes are subject to less corrosion, but are heavy, fragile, and subject to breakage. Plastic and composite planter boxes are more durable and resist corrosion but are subject to deformation due to changes in temperature, are subject to fading in sunlight, and, regardless of deformation, can be less aesthetically pleasing.

### SUMMARY OF THE INVENTION

An object according to this invention is provision of a set of side walls and fasteners that can be assembled together, and disassembled, by a user and without tools into an aesthetically pleasing frame for receiving a pouch of soil.

Another object is the provision of a kit comprising a set of side walls and joint elements that a user can assemble without tools.

Another object of the present invention is to provide a novel and unique transportable planter frame, such as for use in patio settings and atop apartment railings or limited spaces such as condominium balconies.

Another object of the present invention is to provide a novel and unique planter that has side walls and joints that can be readily assembled, or disassembled, without tools into planters of different lengths and widths.

It is to be appreciated that there is a need for an efficient low cost aesthetically assemblable planter with an easily interchangeable soil containment pouch.

According to this invention, there is provided a planter box comprising four generally rectangular side walls having opposite longitudinal ends of like vertical height and an upper end forming a top edge, a joint structure for joining the opposite ends of respective pairs of sidewalls together into a right angled wall structure and the wall structures into an upwardly open frame. The joint structure comprises a plurality of L-shaped corner flanges each formed by a pair of plates at right angles to one another with the inner surfaces of the plates being abutted against and releasably connected to the outwardly facing end portions of a pair of side walls to form one right angled wall structure. The inner surfaces of each plate includes a pair of upwardly extending fastening members. The side walls include a pair of keyholes for receiving the fastening members, and an L-shaped gusset fitted downwardly and seated about the upper brackets of a respective pair of the L-shaped flanges with a stop thereof and seated atop the corner flange and engaging the upper ends of a pair of side walls.

Preferably, although not essential a generally composite pouch or liner for receiving soil is disposed in the upwardly open frame, the pouch being sized to be coextensive with and extend between the opposite pairs of side walls with the bottom of the pouch forming a base of the frame. The pouch is preferably of layered construction, including an inner layer of polymeric material and an outer layer of cloth. Further, the pouch includes a plurality of orifices for allowing excess water in the soil to escape from the pouch.

Preferably, the upper end portion of each side wall includes an inwardly turned bracket, and stops on each of the L-shaped gusset connect to the brackets on two respective side walls when connected together by the corner flange.

In one preferred embodiment, the side walls and the joint structure of the planter are preferably comprised of pre-galvanized powder coated steel.

In another embodiment according to this invention there is provided a kit for assembling a planter box without tools, the kit comprising four generally planar and rectangular side walls, each side wall including an inwardly facing longitudinally extending bracket along its top vertical edge, and a pair of vertically spaced keyholes at each opposite longitudinal end portion, four generally L-shaped corner members, each corner member having a pair of side plates at right angles to one another with each plate including a pair of stems disposed in vertically spaced relation and extending upwardly and away from each respective side plate for receipt in a respective pair of the keyholes in a respective side wall, four L-shaped gusset brackets, each bracket adapted to seat above the top vertical edges of the side walls and connect to the elongate top bracket along the top of the sidewall when the corner plate is connected to a pair of side walls, and a pouch for receiving soil.

The present invention will be more clearly understood with reference to the accompanying drawings and to the following Detailed Description, in which like reference numerals refer to like parts and where:

### BRIEF DESCRIPTION OF THE DRAWINGS

FIG. 1 is a perspective view looking at the parts of a kit used to assemble a planter without tools.

FIG. 2 is a perspective view looking at the assembly of two side walls by a corner member to form a right angled structure.

FIG. 3 is an enlarged view of the corner joint of FIG. 2, formed between two side walls and a corner member.

FIG. 4 is a perspective view looking at the corner joint of FIG. 2 and a gusset positioned for connection to brackets at the top of each of the side walls and the corner joint formed.

FIG. 5 is a perspective view looking at further assembly wherein the four side walls are assembled into a rectangular shape with the corner flange and gusset positioned for connection to two of the side walls.

FIG. 6 is a perspective vie of the assembled planter with a soil pouch disposed within the planter.

### DETAILED DESCRIPTION OF THE PREFERED EMBODIMENT

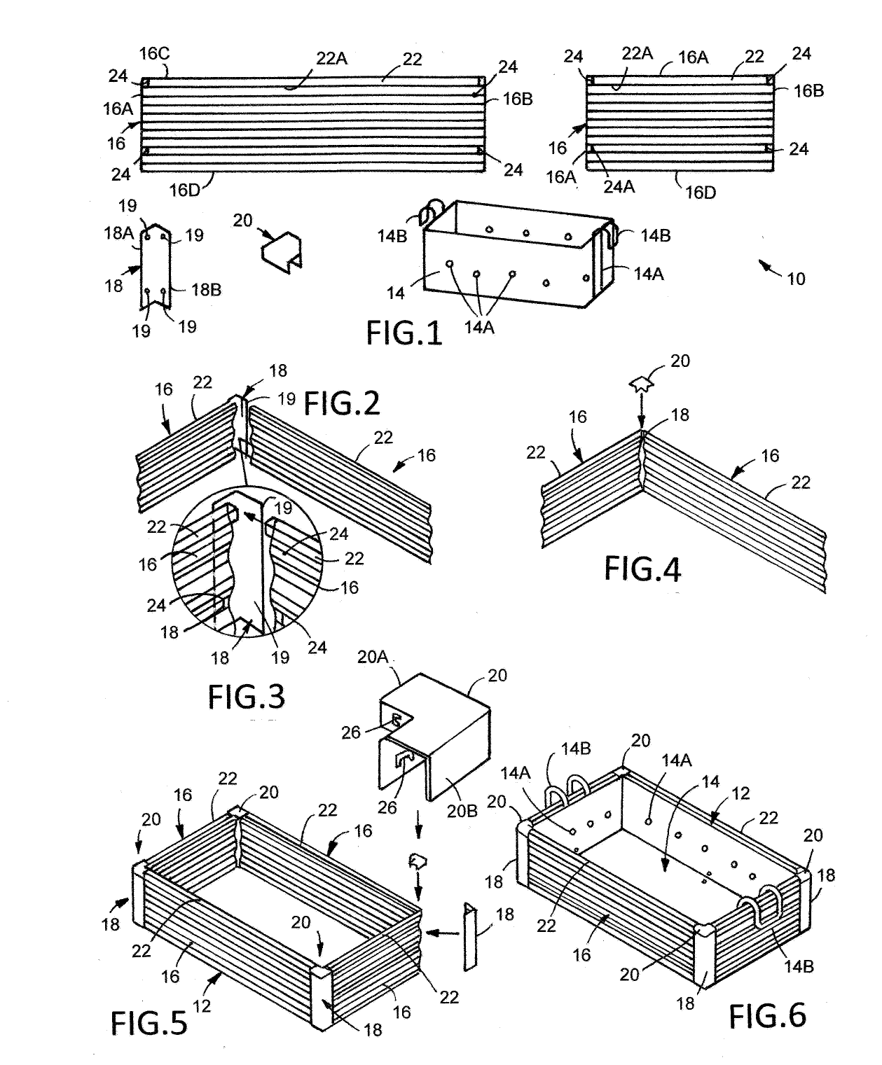

Turning now to the drawings, FIGS. 1-6 illustrate a kit 10 and the assembly of parts of the kit that are assembled without tools to form a planter 12. The planter thus assembled is upwardly and downwardly open and the assembled form receives a soil pouch 14.

Turning to FIG. 1, the kit 10 includes four side walls 16, four corner members 18, four gussets 20, and the soil pouch 14. The sidewalls 16 are generally planar and include opposite longitudinal ends 16A and 16B and upper and lower edges 16C and 16D. The top upper edge 16C of the side wall is formed by an inwardly turned bracket 22 which extends between the opposite longitudinal ends of the side wall. The lower edge 16D of each side wall forms one part of the planter base. Disposed in vertically spaced relation at each longitudinal end of each side wall are two keyholes 24. As shown, two of the side walls are longer than the other two side walls 16 to form a generally rectangular planter frame. The side walls 16 could all be of the same length, if desired.

The side walls 16 are generally of a pre-galvanized powder coated steel, and aesthetically formed with an undulating surface.

The corner members 18 are generally L-shaped and include two flange plates 18A and 18B positioned at right angles to one another. The flange plates form two generally planar inwardly facing surfaces adapted to abut the outer faces of two of the side walls Importantly, the inwardly facing surfaces of the flanges include a pair of vertically spaced keeper stems 19 adapted to be received in a respective pair of keyholes 24 from a sidewall to form one of four right angled connections.

Desirably, the stem and keyhole connection provide an expedient for rapidly joining a pair of members. The stem has a head and a shank of lesser diameter and the keyhole has an opening and slot of lesser width than the opening, the head being received through the keyhole opening and the shank then moved vertically down into the slot, the head being greater than the slot whereby when the shank moves into the slot the head holds the corner member snugly against the wall.

The gusset 20 is generally right angled and includes a pair of downwardly open channels 20A and 20B of U-shaped cross-section, the channels adapted to seat atop the brackets 22 of two joined side walls 16. Importantly, a stop 26 extends inwardly from each channel of the gusset 20 to engage the bottom edge 22A of the bracket 22 and releasably secure the gusset to the corner connection.

The soil pouch 14 for receiving soil is disposed in the upwardly open frame, the pouch being sized to be coextensive with and extend between the opposite pairs of side walls with the bottom of the pouch forming a base of the downwardly open frame. The pouch 14 is preferably of layered construction, including an inner layer of polymeric material and an outer layer of cloth. Further, the pouch includes a plurality of orifices 14A for allowing excess water in the soil to escape from the pouch.

Turning to FIG. 2, a corner member 18 is positioned for connecting a pair of sides, the connection causing the stems to engage into connected relation with the keyholes 24 to connect the side walls 16 together to form a corner of the planter 12.

In FIG. 3, an exploded view of FIG. 2, the corner member 18 is shown positioning the connector stems 19 for connection to the keyholes 24 in two of the side walls 16 to form one right angled corner joint.

In FIG. 4, four side walls 16 have been assembled into a generally rectangular shape, three corner joints have been formed by respective corner members 18 by securing respective pairs of side walls 16 together into at right angles, and gussets 20 engaging wall brackets 22 and forming a complete joint, and a fourth corner member and gusset are poisoned for assembly with two side walls to form the last corner joint of the planter.

In FIG. 5, the four side walls 16 have been connected into a rectangular shape planter frame 12, and the soil pouch 14 is disposed in the interior of the frame. As noted, the pouch includes a plurality of orifices

For ease of use, the pouch 14 includes a pair of handles 14B at opposite ends or sides of the pouch.

Although the present invention has been described with respect to a rectangular planter box, it is to be understood that other geometric configurations may be used herein. However, because of ease of manufacture, etc., a rectangular configuration or confirmation is preferred. Furthermore, although not shown in the drawing, the present planter box may be fitted to seat on a stand or to stanchions to provide an above-ground planter box.

Having, thus, described the invention, what is claimed is:

1. A planter box, comprising:
(a) a substantially rectangular frame including four side walls, each side wall having a pair of bywalls;
(b) a joint structure for joining opposite ends of respective side walls together in a right angled wall structure defining an upwardly open frame; and
(c) a plurality of fastening members for securing the side walls together.

2. The planter box of claim 1, wherein each joint structure comprises:
a plurality of L-shaped corner flanges defined by a pair of plates disposed at right angles to one another, the inner surface of the plates being abutted against and releasably connected to the outward facing end portions of a pair of sidewalls normal to each other to form one right angled wall structure and wherein a pair of the fastening members are disposed on the inner surfaces of each plate.

3. The planter box of claim 2 which further comprises:
an L-shaped gusset disposed downwardly and seated about the upper brackets of a respective pair of the L-shaped flanges, the gusset having a stop and seated atop the associated corner flange and engaging the upper ends of a pair of side walls.

4. The planter box of claim 1, which further comprises:
a soil receiving liner, the liner forming a base for the frame.

5. The planter box of claim 4 wherein the liner comprises:
a first layer of polymeric material and a second layer clothing, the liner having a plurality of drainage openings therethrough.

6. The planter box of claim 3, which further comprises:
an inwardly turned bracket, each gusset having a stop, the stop connecting to the bracket on two respective side walls, when connected together by the corner flange.

7. A kit for forming a planter box without tools, the kit comprising:
The planter box of claim 1 in disassembled form.
